(19) United States
(12) Patent Application Publication
(10) Pub. No.: US 2024/0384752 A1
(43) Pub. Date: Nov. 21, 2024

(54) AIR FOIL JOURNAL BEARING

(71) Applicant: Hanon Systems, Daejeon (KR)

(72) Inventors: Jong Sung Lee, Daejeon (KR); Hyun Chil Kim, Daejeon (KR); Gunwoong Park, Daejeon (KR); Min Gyu Park, Daejeon (KR); Chi Yong Park, Daejeon (KR); Yeol Woo Sung, Daejeon (KR); Hyun Seok Jung, Daejeon (KR); Kyu Sung Choi, Daejeon (KR)

(21) Appl. No.: 18/693,990

(22) PCT Filed: Oct. 17, 2022
(86) PCT No.: PCT/KR2022/015699

§ 371 Date: Mar. 21, 2024

(30) Foreign Application Priority Data
Oct. 27, 2021 (KR) 10-2021-0144500
Jul. 5, 2022 (KR) 10-2022-0082350

(51) Int. Cl. F16C 17/02

(52) U.S. Cl. CPC F16C 17/024

(57) ABSTRACT

The present invention relates to an air foil journal bearing including a bump foil having a plurality of elastic bumps and provided and coupled inside a bearing housing, a mid-foil provided inside the bump foil, formed in a circumferential direction, and having at least one circumferential end coupled to the bearing housing, and a top foil provided inside the mid-foil, formed in the circumferential direction, and having at least one circumferential end coupled to the bearing housing, in which a stepped portion is formed as a radius of an inner peripheral surface of a partial circumferential region of the mid-foil is smaller than a radius of an inner peripheral surface of the remaining region, such that an additional pressure is generated in a section in which a maximum positive pressure is applied when a rotor rotates at low speed, such that the rotor may float at a relatively low rotational speed, and friction and vibration between the rotor and the top foil may be reduced.

### TECHNICAL FIELD

The present invention relates to an air foil journal bearing configured to support a radial load of a rotor by using air pressure generated when the rotor rotates at high speed.

### BACKGROUND ART

An air foil bearing refers to a bearing that supports a load by means of pressure generated as air, which is a fluid having a viscosity, is introduced between foils that adjoin a rotor or bearing disc when a rotor (or rotary shaft) rotates at high speed.

Further, among the air foil bearings, an air foil journal bearing refers to a bearing configured to support a radial load of the rotor that is applied in a direction perpendicular to the rotor.

As illustrated in FIG. 1, a general air foil journal bearing is configured such that bump foils 2a and 2b are installed along an inner peripheral surface of a hollow bearing housing 1, top foils 3a and 3b are disposed inside the bump foils 2a and 2b, and a rotor 4 is disposed inside the top foils 3a and 3b, such that the rotor may rotate in a state in which an inner peripheral surface of the top foil 3 and an outer peripheral surface of the rotor 4 are spaced apart from each other. Further, the bump foils 2a and 2b and the top foils 3a and 3b are each configured such that one circumferential end thereof defines a bent portion bent radially outward, and the bent portion is fixedly inserted into a groove formed in the bearing housing 1. Therefore, in a state in which the rotor is stopped, the rotor is brought into contact with and supported on a lower side of the inner circumferential surface of the top foil. When the rotor operates and rotates, a pressure of air between a lower side of the rotor and the top foil increases, and the rotor floats upward from the inner circumferential surface of the lower side of the top foil and rotates.

In this case, in the air foil journal bearing in the related art, a gap exists between the inner top foil 3a, which is disposed at the innermost side in the radial direction, and the rotor 4, which is disposed inside the inner top foil 3a and rotates, when the rotor rotates. Therefore, air is introduced into the gap by the rotation of the rotor, such that dynamic pressure of the air is generated.

However, because an inclination angle defined between the inner top foil 3a and the rotor 4, between which the air is introduced, is small, the rotor needs to rotate at high speed to increase the dynamic pressure of the air and float the rotor upward from the inner top foil. Therefore, there is a problem in that the friction between the rotor and the inner top foil increases and severe vibration occurs before the rotor floats from the inner top foil.

### Document of Related Art

### Patent Document

WO 2015/005547 A1 (Jan. 15, 2015)

### DISCLOSURE

### Technical Problem

The present invention has been made in an effort to solve the above-mentioned problem, and an object of the present invention is to provide an air foil journal bearing capable of generating an additional pressure in a section in which a maximum positive pressure is applied when a rotor rotates at low speed, such that the rotor may float at a relatively low rotational speed, and friction and vibration between the rotor and a top foil may be reduced.

### Technical Solution

In order to achieve the above-mentioned objects, the present invention provides an air foil journal bearing including: a bump foil having a plurality of elastic bumps and provided and coupled inside a bearing housing; a mid-foil provided inside the bump foil, formed in a circumferential direction, and having at least one circumferential end coupled to the bearing housing; and a top foil provided inside the mid-foil, formed in the circumferential direction, and having at least one circumferential end coupled to the bearing housing, in which a stepped portion is formed as a radius of an inner peripheral surface of a partial circumferential region of the mid-foil is smaller than a radius of an inner peripheral surface of the remaining region.

In addition, the stepped portion of the mid-foil may start from a position spaced apart from a side, which is disposed perpendicularly below a center of the bearing housing, in the circumferential direction and a direction opposite to the rotation direction of the rotor.

In addition, the stepped portion of the mid-foil may extend in the circumferential direction and a rotation direction of a rotor while starting from a position spaced apart from a side, which is disposed perpendicularly below a center of the bearing housing, in the circumferential direction and a direction opposite to the rotation direction of the rotor.

In addition, a start point, from which the stepped portion of the mid-foil starts, may be within a range of 0 to 20 degrees in the direction opposite to the rotation direction of the rotor based on the side disposed perpendicularly below the center of the bearing housing.

In addition, an end point, at which the stepped portion of the mid-foil ends, may be within a range of 0 to 15 degrees in the direction opposite to the rotation direction of the rotor based on a side disposed perpendicularly above the center of the bearing housing.

In addition, the top foil may be formed to be wound by one or more turns, the other end of the top foil may overlap one end of top foil, and the other end of the top foil may be disposed at a position spaced apart from an end point of the stepped portion of the mid-foil.

In addition, the top foil may include: an overlap portion extending in the circumferential direction while overlapping the other end of the top foil; an extension portion bent radially inward in the circumferential direction from an end of the overlap portion; and a support portion extending in the circumferential direction from an end of the extension portion.

In addition, the stepped portion of the mid-foil may be formed by bending a part of a single board with a uniform thickness.

In addition, the mid-foil may be formed such that the remaining region excluding the stepped portion has a smaller thickness than the stepped portion.

In addition, the remaining region excluding the stepped portion of the mid-foil may be formed by etching.

In addition, a stepped portion lateral surface, which is a stepped surface, at any one of or both a start point, from which the stepped portion of the mid-foil starts, and an end point, at which the stepped portion ends, may be formed in parallel with a radial direction.

In addition, a stepped portion lateral surface, which is a stepped surface, at any one of or both a start point, from which the stepped portion of the mid-foil starts, and an end point, at which the stepped portion ends, may be inclined with respect to a radial direction.

In addition, an inclination angle θ1 of the stepped portion lateral surface may be equal to or smaller than a forming angle θ2 of the stepped portion lateral surface.

In addition, the stepped portion of the mid-foil may be formed in a single continuous shape from a start point, from which the stepped portion starts, to an end point at which the stepped portion ends.

In addition, at the start point from which the stepped portion of the mid-foil starts, a stepped portion lateral surface may be formed in a direction perpendicular to a longitudinal direction when the mid-foil is unfolded.

In addition, in a region adjacent to the start point from which the stepped portion of the mid-foil starts, the start point of the stepped portion may be formed at a central portion based on a width direction of the mid-foil, and a width of the stepped portion may gradually increase in a direction in which the stepped portion extends.

In addition, in a region adjacent to a start point from which the stepped portion of the mid-foil starts, at least one groove may be formed in a direction corresponding to a stepped portion lateral surface in a direction in which the stepped portion extends.

In addition, at the start point from which the stepped portion of the mid-foil starts, the stepped portion lateral surface may be formed in a direction perpendicular to a longitudinal direction when the mid-foil is unfolded.

In addition, in a region adjacent to the start point from which the stepped portion of the mid-foil starts, the start point of the stepped portion may be formed at a central portion based on a width direction of the mid-foil, and a width of the stepped portion may gradually increase in a direction in which the stepped portion extends.

In addition, a depth of the groove may be equal to a thickness of a load support portion.

In addition, the groove may be continuously formed from one end to the other end based on a width direction.

### Advantageous Effects

According to the air foil journal bearing of the present invention, the rotor may float at a relatively low rotational speed, such that friction and vibration between the rotor and the top foil may be reduced.

In addition, it is possible to minimize friction between the rotor and the top foil by reducing a level difference caused by structural characteristics of the mid-foil and the top foil.

### BRIEF DESCRIPTION OF THE DRAWINGS

FIG. 1 is a cross-sectional view illustrating an air foil journal bearing in the related art.

FIGS. 2 to 4 are an assembled perspective view, an exploded perspective view, and a front cross-sectional view illustrating an air foil journal bearing according to a first embodiment of the present invention.

FIGS. 5 and 6 are partially enlarged views of FIG. 4.

FIGS. 7 and 8 are an assembled perspective view and a front cross-sectional view illustrating an air foil journal bearing according to a second embodiment of the present invention.

FIG. 9 is a perspective view illustrating a mid-foil of the air foil journal bearing according to the second embodiment of the present invention.

FIG. 10 is a conceptual design view of a mid-foil of the air foil journal bearing according to the first embodiment of the present invention.

FIG. 11 is a conceptual design view of the mid-foil of the air foil journal bearing according to the second embodiment of the present invention.

FIG. 12 is side and top plan development views of the mid-foil of the air foil journal bearing according to the first embodiment of the present invention.

FIG. 13 is side and top plan development views of a mid-foil of an air foil journal bearing according to a third embodiment of the present invention.

FIG. 14 is a perspective view illustrating the mid-foil of the air foil journal bearing according to the third embodiment of the present invention.

FIG. 15 is side and top plan development views of a mid-foil of an air foil journal bearing according to a fourth embodiment of the present invention.

FIG. 16 is a perspective view illustrating the mid-foil of the air foil journal bearing according to the fourth embodiment of the present invention.

FIG. 17 is side and top plan development views of a mid-foil of an air foil journal bearing according to a fifth embodiment of the present invention.

FIG. 18 is a perspective view illustrating the mid-foil of the air foil journal bearing according to the fifth embodiment of the present invention.

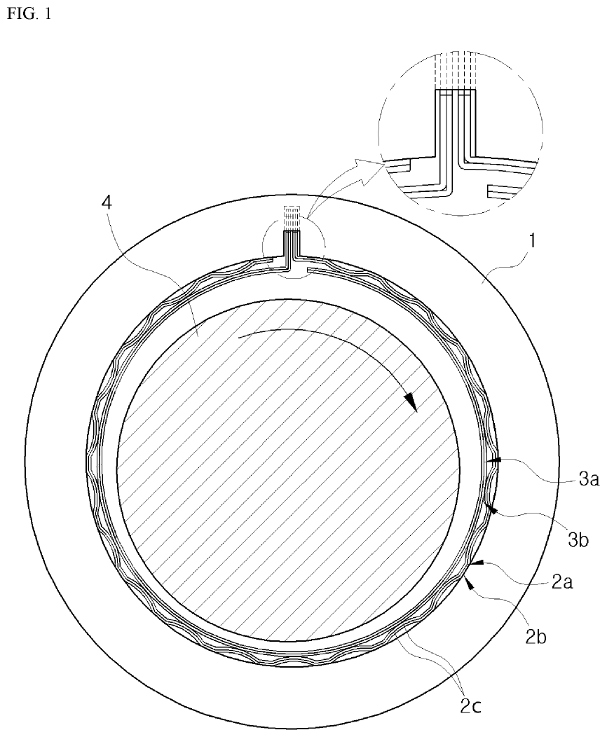

### MODE FOR INVENTION

Hereinafter, an air foil journal bearing of the present invention configured as described above will be described in detail with reference to the accompanying drawings.

### Embodiment 1

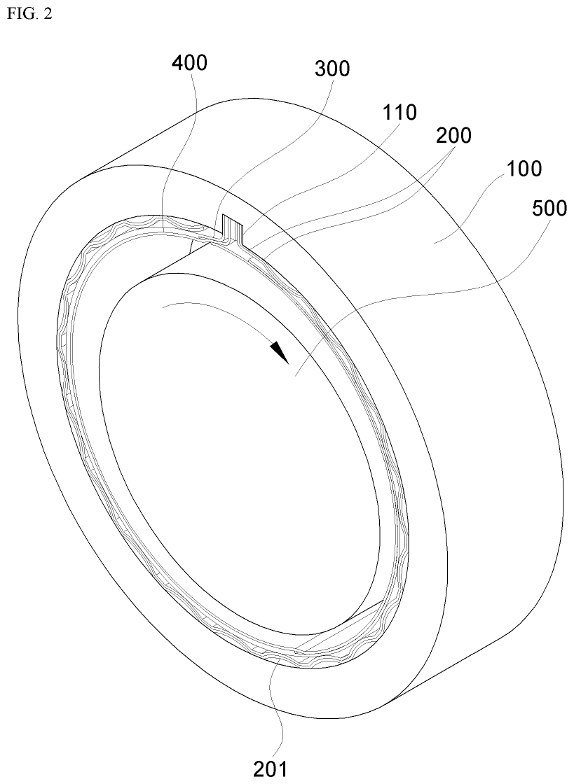

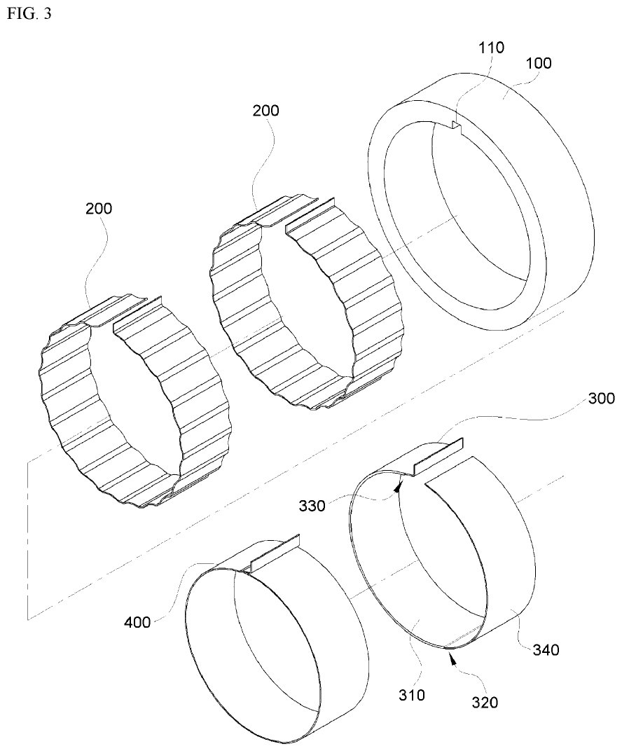

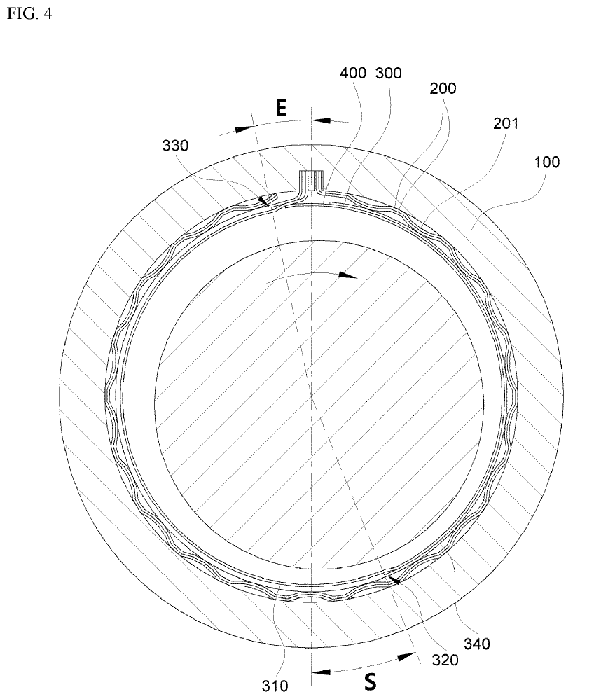

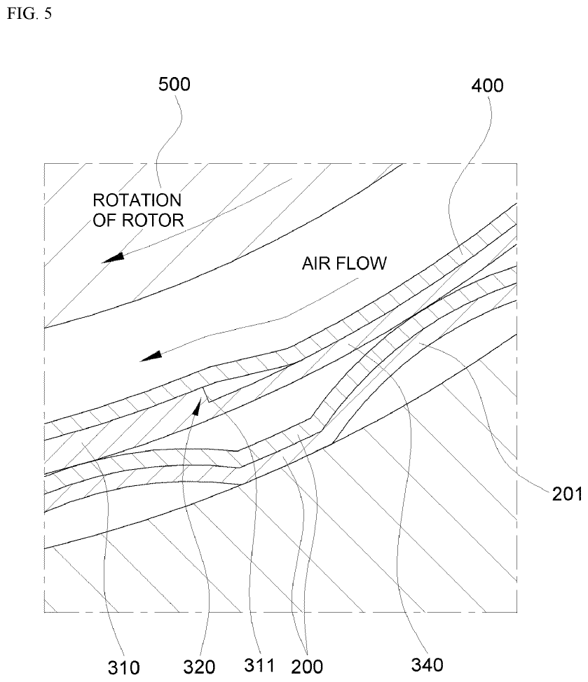

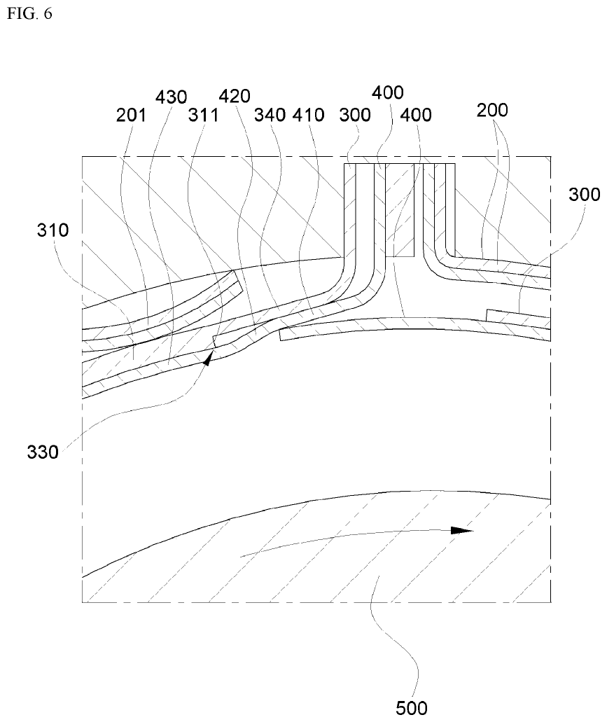

FIGS. 2 to 4 are an assembled perspective view, an exploded perspective view, and a front cross-sectional view illustrating an air foil journal bearing according to a first embodiment of the present invention, and FIGS. 5 and 6 are partially enlarged views of FIG. 4.

As illustrated, the air foil journal bearing according to the first embodiment of the present invention may broadly include a bump foil, a mid-foil, and a top foil and further include a bearing housing. Hereinafter, an embodiment, which includes all the above-mentioned components, will be described.

A bearing housing 100 may have an inner hollow portion formed through the bearing housing 100 in a direction of a center axis and have a cylindrical shape or a ring shape. A slot 110 may be concavely formed at an upper side of an inner peripheral surface of the bearing housing 100 in the direction of the center axis.

A bump foil 200 may be disposed inside the bearing housing 100, and the bump foil 200 and provided to be in close contact with the inner peripheral surface of the bearing housing 100. One circumferential end of the bump foil 200 may be bent radially outward, and the bent portion may be inserted and fixedly coupled into the slot 110 of the bearing housing 100. Further, the bump foil 200 may be disposed along the inner peripheral surface of the bearing housing 100 and have a plurality of elastic bumps 201 convexly protruding radially inward in a circumferential direction. In addition, the bump foil 200 may extend clockwise based on one end of the bump foil 200 coupled to the bearing housing 100. In addition, the bump foil 200 may be provided as two sheets of bump foils. However, a single sheet of bump foil or three sheets of bump foils may be provided. In addition, the number of bump foils and the shape of the bump foil may be variously implemented.

One circumferential end of a mid-foil 300 may be bent radially outward, and the bent portion may be inserted and fixedly coupled into the slot 110 of the bearing housing 100. Further, the mid-foil 300 may be disposed in the circumferential direction in which crests of the elastic bumps 201 of the bump foil 200 are disposed, and the mid-foil 300 may be in contact with the bump foil 200. The mid-foil 300 may extend counterclockwise based on one end of the mid-foil 300 coupled to the bearing housing 100.

In this case, the mid-foil 300 may have a stepped portion 310 formed as a radius of an inner peripheral surface of a partial circumferential region of the mid-foil 300 is smaller than a radius of an inner peripheral surface of the remaining region of the mid-foil 300 based on a center of the bearing housing 100. As illustrated, the mid-foil 300 may have a load support portion 340 having a relatively large thickness, and the stepped portion 310 may have a larger thickness than the load support portion 340. Further, the stepped portion 310 may extend in a rotation direction of a rotor 500 from a position slightly spaced apart from a side, which is disposed perpendicularly below the center of the bearing housing 100, in the counterclockwise direction opposite to the direction in which the rotor 500 rotates.

One circumferential end of a top foil 400 may be bent radially outward, and the bent portion may be inserted and fixedly coupled into the slot 110 of the bearing housing 100. Further, the top foil 400 may be disposed in a circumferential direction of an inner peripheral surface of the mid-foil 300 and provided to be in contact with the mid-foil 300. The top foil 400 may extend counterclockwise based on one end of the top foil 400 coupled to the bearing housing 100.

Therefore, in the air foil journal bearing of the present invention, a shape of the top foil 400 is deformed in the vicinity of a stepped portion start point 320 of the mid-foil 300, as illustrated in FIG. 5, such that an inclination angle defined between the rotor 500 and the top foil 400 may increase. Therefore, because the stepped portion of the mid-foil generates an additional air pressure in a section in which a maximum positive pressure is applied when the rotor rotates at low speed, the rotor may float at a relatively low rotational speed, such that friction and vibration between the rotor and the top foil may be reduced.

In addition, based on the side (angle of 0 degrees) disposed perpendicularly below the center of the bearing housing 100, an angle range S of the position of the stepped portion start point 320, from which the stepped portion 310 of the mid-foil 300 starts in the direction opposite to the rotation direction of the rotor, may be 0 to 20 degrees. A maximum positive pressure of air is applied in this region when the rotor 500 rotates. Because the stepped portion 310 of the mid-foil 300 starts from this region, the shape of the top foil 400 is deformed by the shape of the stepped portion start point 320, such that an additional pressure may be generated.

In addition, with reference to FIG. 6, the stepped portion 310 of the mid-foil 300 extends in the rotation direction of the rotor 500 from the stepped portion start point 320, such that the stepped portion 310 may be formed to a position adjacent to one end of the mid-foil 300. Further, the top foil 400 may be wound by one or more turns, such that the other end of the top foil 400 may overlap one end of the top foil 400. The other end of the top foil 400 may be disposed at a position spaced apart from an end point 330 of the stepped portion of the mid-foil 300. In this case, based on a side (angle of 0 degrees) disposed perpendicularly above the center of the bearing housing 100, an angle range E of a position of the stepped portion end point 330, at which the stepped portion 310 of the mid-foil 300 ends in the direction opposite to the rotation direction of the rotor, may be 0 to 15. A negative pressure of air is generated in this region when the rotor 500 rotates. Because the stepped portion 310 of the mid-foil 300 ends in this region, the shape of the top foil 400 is deformed by the shape of the stepped portion end point 330. Therefore, a shape, which defines an inner peripheral surface of the top foil 400, may define one circular shape without a portion protruding radially inward when the other end and one end of the top foil 400 overlap each other.

Therefore, vibration may be reduced in the negative pressure generation region formed at the upper side of the rotor 500, such that the dynamic stability may be improved, and the friction between the top foil 400 and the rotor 500 may be reduced by the structural characteristics.

In addition, the top foil 400 may include an overlap portion 410, an extension portion 420, and a support portion 430. The overlap portion 410 may be one end portion of the top foil 400 that overlaps the other end of the top foil 400. The overlap portion 410 may extend counterclockwise based on the bent portion of the top foil 400 inserted into the slot 110 of the bearing housing 100. The extension portion 420 may be formed in a shape bent radially inward from the end of the overlap portion 410 in the counterclockwise direction. The support portion 430 may extend counterclockwise from the end of the extension portion 420 to the other end of the top foil 400. Therefore, when the other end of the top foil 400 overlaps the overlap portion 410, an inner peripheral surface of the other end of the top foil 400 may be disposed on the same circumference line as or disposed radially outward from an inner peripheral surface of the support portion 430 adjacent to the extension portion 420 without a structural level difference.

In addition, the mid-foil 300 may be formed by using and processing a single board with a uniform thickness so that the load support portion 340, which is the remaining portion excluding the region to be formed as the stepped portion 310, has a relatively small thickness. That is, the mid-foil 300 may be formed by processing a single board with a uniform thickness by various methods so that the thickness of the load support portion 340 is smaller than the thickness of the stepped portion 310. For example, the mid-foil 300 may be formed such that the remaining portion excluding the stepped portion 310 may be formed to have a relatively small thickness by etching.

### Embodiment 2

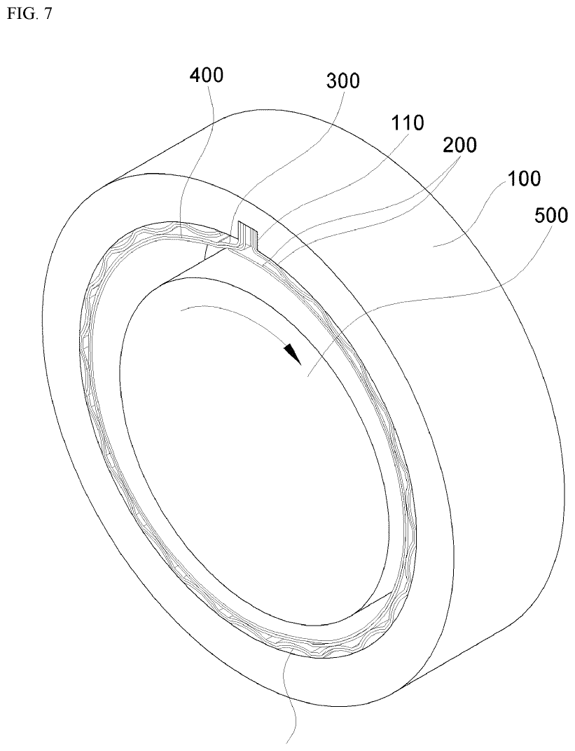

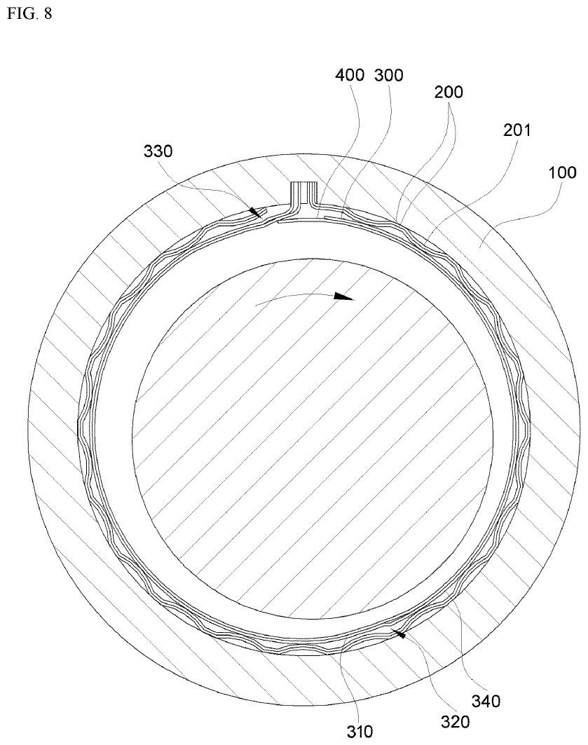

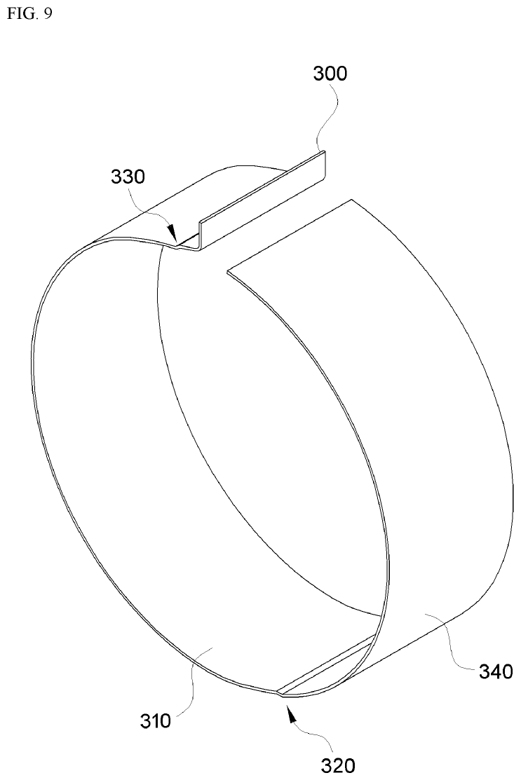

FIGS. 7 and 8 are an assembled perspective view and a front cross-sectional view illustrating an air foil journal bearing according to a second embodiment of the present invention, and FIG. 9 is a perspective view illustrating a mid-foil of the air foil journal bearing according to the second embodiment of the present invention.

As illustrated, the air foil journal bearing according to the second embodiment of the present invention may broadly include a bump foil, a mid-foil, and a top foil and further include a bearing housing.

The air foil journal bearing according to the second embodiment of the present invention may be identical in configuration to the air foil journal bearing according to the first embodiment, except for the mid-foil 300.

A stepped portion of the mid-foil 300 may be formed by bending a part of a single board with a uniform thickness. That is, as illustrated, the mid-foil 300 may be formed such that the stepped portion 310 is disposed radially inward of the load support portion 340 as a portion of the stepped portion start point 320, from which the stepped portion 310 of the mid-foil 300 starts, is bent and a portion of the stepped portion end point 330, at which the stepped portion 310 ends, is bent. Therefore, the stepped portion may be simply configured without a waste of a material used to form the mid-foil 300.

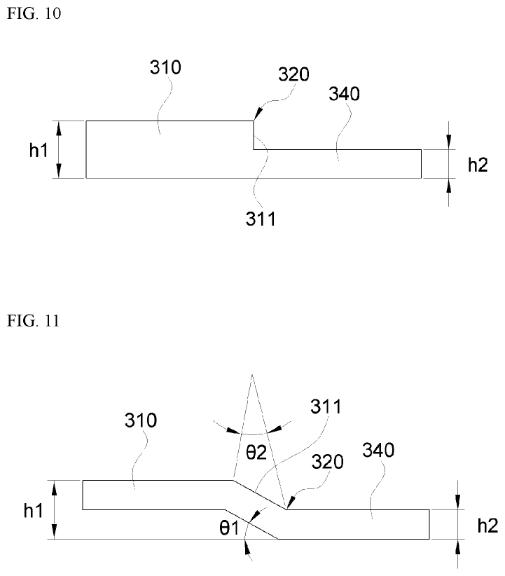

FIG. 10 is a conceptual design view of a mid-foil of the air foil journal bearing according to the first embodiment of the present invention, and FIG. 11 is a conceptual design view of the mid-foil of the air foil journal bearing according to the second embodiment of the present invention.

As illustrated, according to both the first and second embodiments of the present invention, a stepped portion lateral surface 311, i.e., a stepped surface provided at any one of or both the stepped portion start point 320, from which the stepped portion 310 of the mid-foil 300 starts, and the stepped portion end point 330, at which the stepped portion 310 ends, may be formed in parallel with the radial direction. Alternatively, the stepped portion lateral surface 311, i.e., the stepped surface provided at any one of or both the stepped portion start point 320, from which the stepped portion 310 of the mid-foil 300 starts, and the stepped portion end point 330, at which the stepped portion 310 ends, may be formed to be inclined at a particular angle with respect to the radial direction. That is, as illustrated in FIG. 10, an inner peripheral surface of the load support portion 340 of the mid-foil 300 and the stepped portion lateral surface 311 may be formed to be perpendicular to each other. As illustrated in FIG. 11, the stepped portion lateral surface 311 may be inclined at an acute angle with respect to the load support portion 340. In this case, a difference (H=h1-h2) between a height h1 of the stepped portion 310 and a height h2 of the load support portion 340 may be set to any value. An inclination angle θ1 of the stepped portion lateral surface 311 may be equal to or smaller than a forming angle θ2 at which the stepped surface is formed with respect to the center of the bearing housing 100 (01≤02).

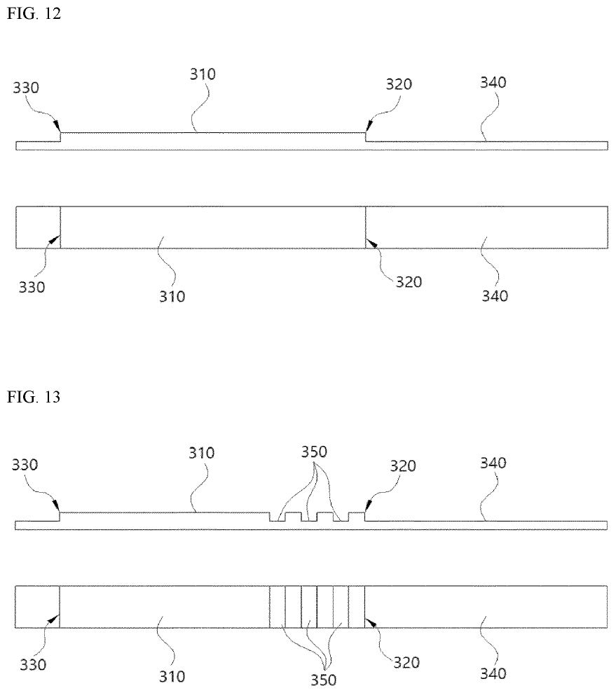

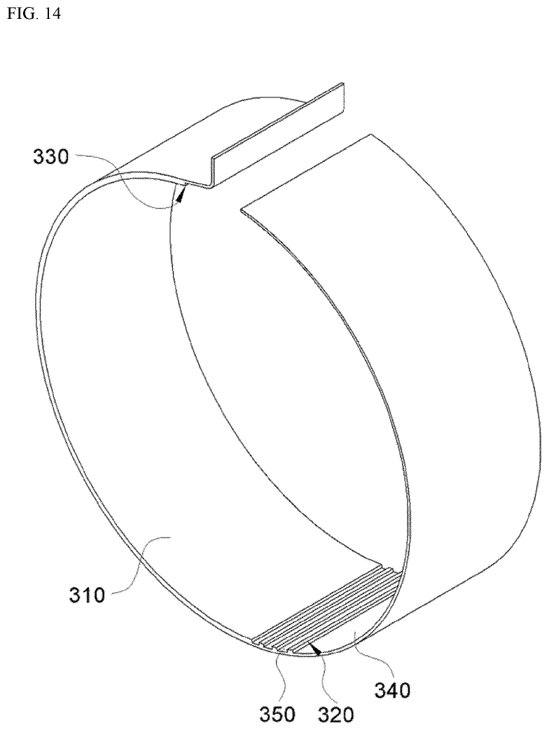

FIG. 12 is side and top plan development views of the mid-foil of the air foil journal bearing according to the first embodiment of the present invention, FIG. 13 is side and top plan development views of a mid-foil of an air foil journal bearing according to a third embodiment of the present invention, and FIG. 14 is a perspective view illustrating the mid-foil of the air foil journal bearing according to the third embodiment of the present invention.

First, with reference to FIG. 12, in the first embodiment of the present invention, the mid-foil 300 may be formed in a single continuous shape from the stepped portion start point 320, from which the stepped portion 310 starts, to the stepped portion end point 330 at which the stepped portion 310 ends. In this case, the thickness of the stepped portion 310 may be uniform from the stepped portion start point 320 to the stepped portion end point 330. Further, when the mid-foil 300 is unfolded flat, the stepped portion lateral surface 311 may be formed in a direction (width direction) perpendicular to the longitudinal direction at the start point from which the stepped portion 310 starts. In this case, the stepped portion lateral surface 311 may be formed as a single flat surface.

Further, with reference to FIGS. 13 and 14, in the third embodiment of the present invention, the mid-foil 300 may have grooves 350 formed in the width direction, i.e., the direction corresponding to the stepped portion lateral surface 311 in the direction in which the stepped portion extends from a region adjacent to the stepped portion start point 320 from which the stepped portion 310 starts. One or more grooves 350 may be formed. As illustrated, a plurality of grooves 350 may be arranged to be spaced apart from each other.

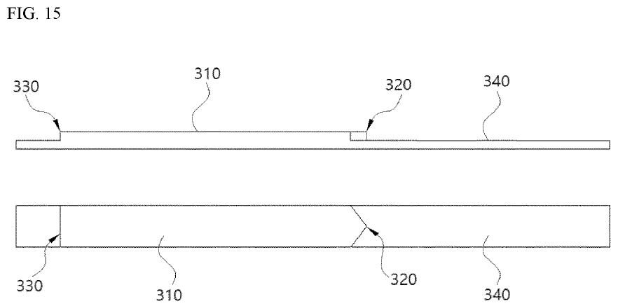

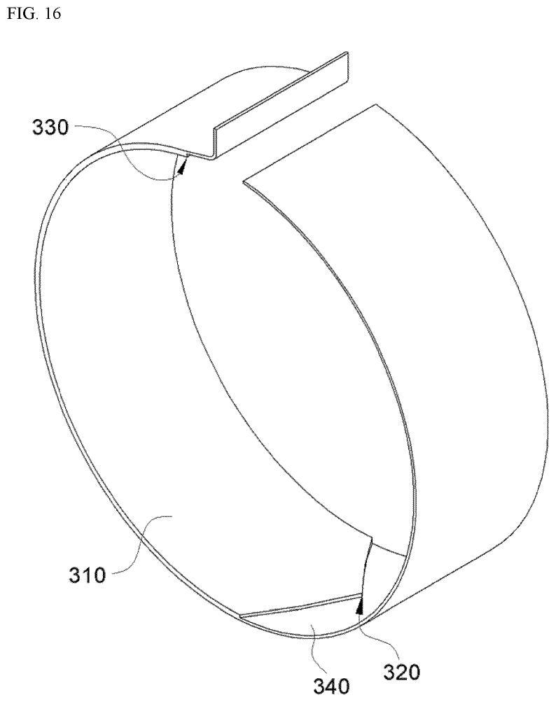

FIG. 15 is side and top plan development views of a mid-foil of an air foil journal bearing according to a fourth embodiment of the present invention, and FIG. 16 is a perspective view illustrating the mid-foil of the air foil journal bearing according to the fourth embodiment of the present invention.

As illustrated, in the fourth embodiment of the present invention, the mid-foil 300 may have the stepped portion start point 320 formed at the central portion of the mid-foil based on the width direction and disposed in a region adjacent to the stepped portion start point 320 from which the stepped portion 310 starts. A width of the stepped portion may gradually increase in the rotation direction of the rotor, i.e., the direction in which the stepped portion 310 extends. That is, in a plan view in which the mid-foil is unfolded, the stepped portion 310 may be formed in a “V” shape in the vicinity of the stepped portion start point 320.

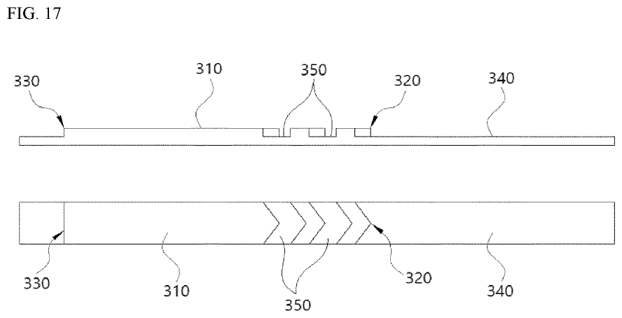

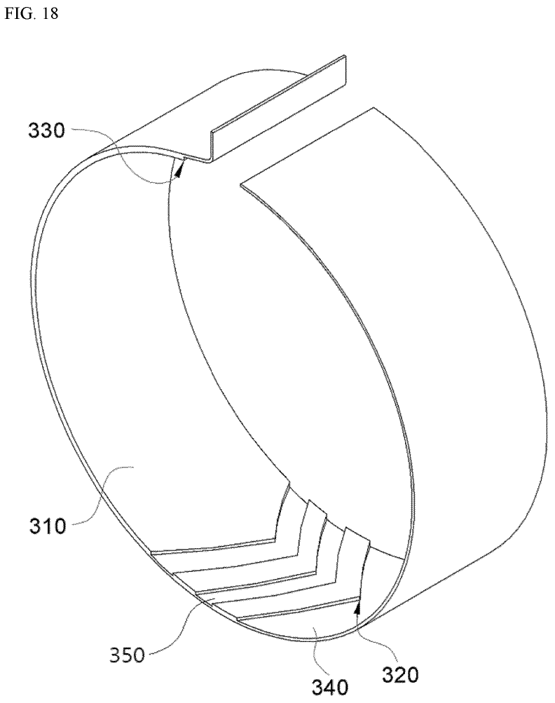

FIG. 17 is side and top plan development views of a mid-foil of an air foil journal bearing according to a fifth embodiment of the present invention, and FIG. 18 is a perspective view illustrating the mid-foil of the air foil journal bearing according to the fifth embodiment of the present invention.

As illustrated, in the fifth embodiment of the present invention, the mid-foil 300 may have grooves 350 formed in the direction corresponding to the stepped portion lateral surface 311 while having the shape corresponding to the stepped portion lateral surface 311 in the direction in which the stepped portion extends from the region adjacent to the stepped portion start point 320 from which the stepped portion 310 starts. One or more grooves 350 may be formed. As illustrated, a plurality of grooves 350 may be arranged to be spaced apart from each other.

In addition, a depth of the groove 350 may be equal to a thickness of the load support portion 340. Further, the groove 350 may be provided in the form of a groove by etching.

In addition, the groove 350 may be continuously formed from one end to the other end in the width direction.

As described above, the width of the stepped portion 310 increases from the stepped portion start point 320 or the groove 350 is formed in the stepped portion 310 and disposed in the region adjacent to the stepped portion start point 320, such that friction between the mid-foil 300 and the top foil 400 in the vicinity of the stepped portion start point 320 may be reduced, and the cooling effect may also be improved.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Bearing housing
110: Slot
200: Bump foil
201: Elastic bump
300: Mid-foil
310: Stepped portion
311: Stepped portion lateral surface
320: Stepped portion start point
330: Stepped portion end point
340: Load support portion
350: Groove
400: Top foil
410: Overlap portion
420: Extension portion
430: Support portion
500: Rotor
S: Angle range of stepped portion start point position
E: Angle range of stepped portion end point position
θ1: Inclination angle of stepped portion lateral surface
θ2: Forming angle of stepped portion lateral surface
h1: Height of stepped portion
h2: Height of load support portion
H: Difference in height (h1-h2) between stepped portion and load support portion

What is claimed is:

1. An air foil journal bearing comprising:
a bump foil having a plurality of elastic bumps and provided and coupled inside a bearing housing;
a mid-foil provided inside the bump foil, formed in a circumferential direction, and having at least one circumferential end coupled to the bearing housing; and
a top foil provided inside the mid-foil, formed in the circumferential direction, and having at least one circumferential end coupled to the bearing housing,
wherein a stepped portion is formed as a radius of an inner peripheral surface of a partial circumferential region of the mid-foil is smaller than a radius of an inner peripheral surface of the remaining region.

2. The air foil journal bearing of claim 1, wherein the stepped portion of the mid-foil extends in the circumferential direction and a rotation direction of a rotor while starting from a position spaced apart from a side, which is disposed perpendicularly below a center of the bearing housing, in the circumferential direction and a direction opposite to the rotation direction of the rotor.

3. The air foil journal bearing of claim 2, wherein a start point, from which the stepped portion of the mid-foil starts, is within a range of 0 to 20 degrees in the direction opposite to the rotation direction of the rotor based on the side disposed perpendicularly below the center of the bearing housing.

4. The air foil journal bearing of claim 2, wherein an end point, at which the stepped portion of the mid-foil ends, is within a range of 0 to 15 degrees in the direction opposite to the rotation direction of the rotor based on a side disposed perpendicularly above the center of the bearing housing.

5. The air foil journal bearing of claim 4, wherein the top foil is formed to be wound by one or more turns, the other end of the top foil overlaps one end of top foil, and the other end of the top foil is disposed at a position spaced apart from an end point of the stepped portion of the mid-foil.

6. The air foil journal bearing of claim 5, wherein the top foil comprises:
an overlap portion extending in the circumferential direction while overlapping the other end of the top foil;
an extension portion bent radially inward in the circumferential direction from an end of the overlap portion; and
a support portion extending in the circumferential direction from an end of the extension portion.

7. The air foil journal bearing of claim 1, wherein the stepped portion of the mid-foil is formed by bending a part of a single board with a uniform thickness.

8. The air foil journal bearing of claim 1, wherein the mid-foil is formed such that the remaining region excluding the stepped portion has a smaller thickness than the stepped portion.

9. The air foil journal bearing of claim 8, wherein the remaining region excluding the stepped portion of the mid-foil is formed by etching.

10. The air foil journal bearing of claim 1, wherein a stepped portion lateral surface, which is a stepped surface, at any one of or both a start point, from which the stepped portion of the mid-foil starts, and an end point, at which the stepped portion ends, is formed in parallel with a radial direction.

11. The air foil journal bearing of claim 1, wherein a stepped portion lateral surface, which is a stepped surface, at any one of or both a start point, from which the stepped portion of the mid-foil starts, and an end point, at which the stepped portion ends, is inclined with respect to a radial direction.

12. The air foil journal bearing of claim 11, wherein an inclination angle θ1 of the stepped portion lateral surface is equal to or smaller than a forming angle θ2 of the stepped portion lateral surface.

13. The air foil journal bearing of claim 1, wherein the stepped portion of the mid-foil is formed in a single continuous shape from a start point, from which the stepped portion starts, to an end point at which the stepped portion ends.

14. The air foil journal bearing of claim 13, wherein at the start point from which the stepped portion of the mid-foil starts, a stepped portion lateral surface is formed in a direction perpendicular to a longitudinal direction when the mid-foil is unfolded.

15. The air foil journal bearing of claim 13, wherein in a region adjacent to the start point from which the stepped portion of the mid-foil starts, the start point of the stepped portion is formed at a central portion based on a width direction of the mid-foil, and a width of the stepped portion gradually increases in a direction in which the stepped portion extends.

16. The air foil journal bearing of claim 1, wherein in a region adjacent to a start point from which the stepped portion of the mid-foil starts, at least one groove is formed in a direction corresponding to a stepped portion lateral surface in a direction in which the stepped portion extends.

17. The air foil journal bearing of claim 16, wherein at the start point from which the stepped portion of the mid-foil starts, the stepped portion lateral surface is formed in a direction perpendicular to a longitudinal direction when the mid-foil is unfolded.

18. The air foil journal bearing of claim 16, wherein in a region adjacent to the start point from which the stepped portion of the mid-foil starts, the start point of the stepped portion is formed at a central portion based on a width direction of the mid-foil, and a width of the stepped portion gradually increases in a direction in which the stepped portion extends.

19. The air foil journal bearing of claim 16, wherein a depth of the groove is equal to a thickness of a load support portion.

20. The air foil journal bearing of claim 16, wherein the groove is continuously formed from one end to the other end based on a width direction.
